(19) United States
(12) Patent Application Publication
(10) Pub. No.: US 2017/0058779 A1
(43) Pub. Date: Mar. 2, 2017

(54) ENGINE LUBRICATION SYSTEM USING DE-OXYGENATED FUEL

(71) Applicant: ROLLS-ROYCE plc, London (GB)

(72) Inventors: Giles E. HARVEY, Derby (GB); Martyn RICHARDS, Burton-on-Trent (GB)

(73) Assignee: ROLLS-ROYCE plc, London (GB)

(21) Appl. No.: 15/139,839

(22) Filed: Apr. 27, 2016

(30) Foreign Application Priority Data
May 21, 2015 (GB) 1508702.6

(51) Int. Cl. F02C 7/224; F23R 3/42; F02C 7/12; F23R 3/34

(52) U.S. Cl. CPC F02C 7/224; F23R 3/34; F23R 3/42; F02C 7/12; F05D 2220/32; F05D 2240/50; F05D 2260/40311

(57) ABSTRACT

A thermal management system for a gas turbine engine comprises a plurality of first heat generating sub-systems arranged in operable communication with the engine, a fuel supply sub-system, a fuel circulation sub-system, and one or more combustors. The fuel supply sub-system is adapted to supply a de-oxygenated fuel to the fuel circulation sub-system, and the fuel circulation sub-system is adapted to circulate the de-oxygenated fuel to lubricate and cool each of the plurality of first heat generating sub-systems, and then to combust the de-oxygenated fuel in the or each combustor.

This disclosure claims the benefit of UK Patent Application No. GB1508702.6, filed on 21 May 2015, which is hereby incorporated herein in its entirety.

### FIELD OF THE DISCLOSURE

The present disclosure relates to a system and method for managing heat transfer in an engine and particularly, but not exclusively, to a system and method for managing heat transfer in an aircraft gas turbine engine.

### BACKGROUND TO THE DISCLOSURE

It is well known for aircraft engine heat management systems to use an existing oil circulation system to transfer heat to the engine's fuel via one or more heat exchangers. However, such systems involve the use of separate engine lubrication, and fuel heat transfer systems, which are linked only through integrated heat exchangers.

The engine lubrication system has its own lubricant storage, filtration, delivery, scavenge and thermal management system typically mounted on the engine alongside the fuel delivery system.

Typical engine fuels have a limited heat capacity due to their susceptibility to coking. The coking of a typical engine fuel will typically commence at approximately 150° C. This restricts the quantity of heat that can be transferred to the fuel so inhibiting the complete replacement of an oil circulation system for heat transfer, unless a large quantity of heat exchangers have been used to regulate the temperature of the oil.

### STATEMENTS OF DISCLOSURE

According to a first aspect of the present disclosure there is provided a thermal management system for a gas turbine engine, the thermal management system comprising:
a plurality of first heat generating sub-systems arranged in operable communication with the engine;
a fuel supply sub-system;
a fuel circulation sub-system; and
one or more combustors,

wherein the fuel supply sub-system is adapted to supply a de-oxygenated fuel to the fuel circulation sub-system, and the fuel circulation sub-system is adapted to circulate the de-oxygenated fuel to lubricate and cool each of the plurality of first heat generating sub-systems, and then to combust the de-oxygenated fuel in the or each combustor.

Using deoxygenated fuel increases the coking limit temperature of the fuel to approximately 300° C. This makes the de-oxygenated fuel capable of being used as the sole heat transfer medium over the entire operating envelope of the engine.

The elimination of the oil circulation system provides several benefits. Firstly, the weight of the engine installation will be considerably reduced by the elimination of the lubricating oil pumps, oil filters, oil pressure regulators, oil reservoirs and heat exchangers. The weight benefit is likely to be around 3% of the weight of a complete engine assembly (typically 200 kg) on a large turbofan engine and may be greater on a smaller engine.

Secondly, the aerodynamic drag associated with the air flows through the requisite oil/air heat exchangers will be eliminated. Thirdly, the elimination of the space required for the oil circuit components will enable the engine installation to be more compact.

The current trend towards the use of more high power gear drives in aircraft geared turbofan architectures will require relatively larger quantities of oil to manage the increased heat generation resulting from the additional transmission loss. The above-mentioned benefits of the system of the disclosure will become more advantageous in these new applications.

Optionally, the fuel circulation sub-system comprises a fuel flow rate modulating sub-system, the fuel flow rate modulating sub-system being adapted to vary a flow rate of the fuel in a pre-determined manner.

Different areas of the engine will have differing requirements for the flow rate of the fuel through the area in order to most efficiently cool and lubricate the assemblies in these areas. By varying the flow rate of the fuel to different parts of the engine, the energy required to circulate the fuel through the entire system can be optimised so making the system more efficient.

Optionally, the first heat generating sub-systems are selected from the group comprising bearing compartments, gearbox assemblies, and power transmission assemblies.

Bearing compartments, gearbox assemblies and power transmission assemblies are the main sources of mechanically generated heat in an aircraft turbofan engine.

In other arrangements, the first heat generating sub-system may be another mechanical sub-system of the engine, such as an actuator, or another movable component.

Optionally, the thermal management system further comprises a fuel deoxygenating sub-system, the fuel de-oxygenating sub-system being adapted to remove dissolved oxygen from the fuel prior to the de-oxygenated fuel entering the fuel supply sub-system.

Integrating the de-oxygenation system into the thermal management system of the disclosure makes the thermal management system able to de-oxygenate a standard fuel for use in the engine. This makes the thermal management system of the disclosure more efficient and cost effective to a user.

In another arrangement, the thermal management system is supplied with a pre-determined quantity of de-oxygenated fuel.

Optionally, the gas turbine engine comprises one or more combustors, and the fuel circulation sub-system comprises a bypass fuel feed adapted to supply a fuel feed to the or each combustor, the bypass fuel feed flow rate being independent of the fuel flow rate through each of the plurality of first heat generating sub-systems.

The engine combustors will require a supply of fuel at a flow rate that is dependent upon the demanded engine power output. This will differ from the flow rate of the fuel used to lubricate and cool the heat generating sub-systems of the engine.

Optionally, the thermal management system further comprises one or more second heat generating sub-systems, wherein the second heat generating sub-systems are selected from the group comprising turbine air cooling units, turbine exhaust gas heat recirculators, exhaust nozzle coolers, and engine casing coolers,
wherein the fuel circulation sub-system is further adapted to circulate the de-oxygenated fuel to cool each of the plurality of second heat generating sub-systems.

The second heat generating sub-systems include parts of the engine that require cooling but do not require lubrication.

Optionally, the fuel is used as a hydraulic medium in one or more hydraulic actuators.

The use of fuel as a hydraulic medium provides for the elimination of the additional storage of a separate hydraulic fluid for us in the hydraulic actuators. This makes the system more weight efficient and simpler.

Optionally, the thermal management system further comprises one or more fuel to air heat exchangers, the or each heat exchanger being configured to transfer heat energy from the fuel to an air flow.

In applications for which additional cooling of the first and/or second heat generating sub-systems is required, the fuel may be circulated through one or more air/fuel heat exchangers.

According to a second aspect of the present disclosure there is provided an aircraft comprising one or more gas turbine engines, the or each gas turbine engine comprising a thermal management system according to the first aspect.

According to a third aspect of the present disclosure there is provided a method of managing thermal transfer in a gas turbine engine, the gas turbine engine comprising one or more combustors, the method comprising the steps of:
providing a supply of deoxygenated fuel;
circulating the fuel through a plurality of first heat generating sub-systems arranged in operable communication with the engine to lubricate each of the first heat generating sub-systems;
transferring thermal energy from each of the first heat generating sub-systems to the fuel; and
combusting the fuel in the or each combustor.

By transferring thermal energy from each of the first heat-generating sub-systems to the fuel, and by lubricating each of the first heat-generating sub-systems, the method of the disclosure enables the engine to be lighter and less complex than a conventional gas turbine engine.

A further advantage of the method of the disclosure is that by transferring thermal energy from the oil into the fuel that is subsequently burnt in the engine, it enables the recovery of thermodynamic energy that would otherwise be largely lost. This provides for a significant improvement in Specific Fuel Consumption (SFC).

Optionally, the first heat generating sub-systems are selected from the group comprising bearing compartments, gearbox assemblies, and power transmission assemblies.

Optionally, the method comprises the additional step of:
circulating the fuel through one or more second heat generating sub-systems arranged in operable communication with the engine to cool each of the second heat generating sub-systems.

Optionally, the second heat generating sub-systems are selected from the group comprising turbine air cooling units, turbine exhaust gas heat recirculators, exhaust nozzle coolers, and engine casing coolers

Other aspects of the disclosure provide devices, methods and systems which include and/or implement some or all of the actions described herein. The illustrative aspects of the disclosure are designed to solve one or more of the problems herein described and/or one or more other problems not discussed.

### BRIEF DESCRIPTION OF THE DRAWINGS

There now follows a description of an embodiment of the disclosure, by way of non-limiting example, with reference being made to the accompanying drawings in which:

FIG. 1 shows a schematic layout view of a thermal management system according to an embodiment of the disclosure; and

FIG. 2 shows a schematic layout view of the system of FIG. 1 with the addition of hydraulic power to an actuator.

It is noted that the drawings may not be to scale. The drawings are intended to depict only typical aspects of the disclosure, and therefore should not be considered as limiting the scope of the disclosure. In the drawings, like numbering represents like elements between the drawings.

### DETAILED DESCRIPTION

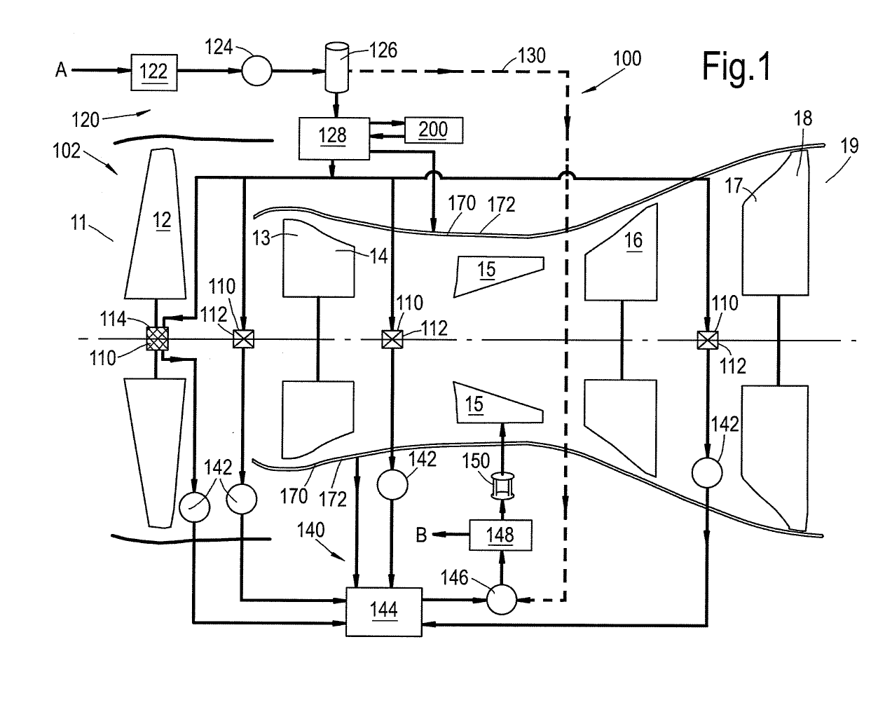

A turbofan gas turbine engine 102, as shown in FIG. 1, comprises in flow series an intake 11, a fan 12, an intermediate pressure compressor 13, a high pressure compressor 14, a combustion chamber 15, a high pressure turbine 16, an intermediate pressure turbine 17, a low pressure turbine 18 and an exhaust 19. The high pressure turbine 16 is arranged to drive the high pressure compressor 14 via a first shaft (not shown). The intermediate pressure turbine 17 is arranged to drive the intermediate pressure compressor 13 via a second shaft (not shown) and the low pressure turbine 18 is arranged to drive the fan 12 via a third shaft (not shown). In operation air flows into the intake 11 and is compressed by the fan 12. A first portion of the air flows through, and is compressed by, the intermediate pressure compressor 13 and the high pressure compressor 14 and is supplied to the combustion chamber 15. Fuel is injected into the combustion chamber 15 and is burnt in the air to produce hot exhaust gases which flow through, and drive, the high pressure turbine 16, the intermediate pressure turbine 17 and the low pressure turbine 18. The hot exhaust gases leaving the low pressure turbine 18 flow through the exhaust 19 to provide propulsive thrust. A second portion of the air bypasses the main engine to provide propulsive thrust.

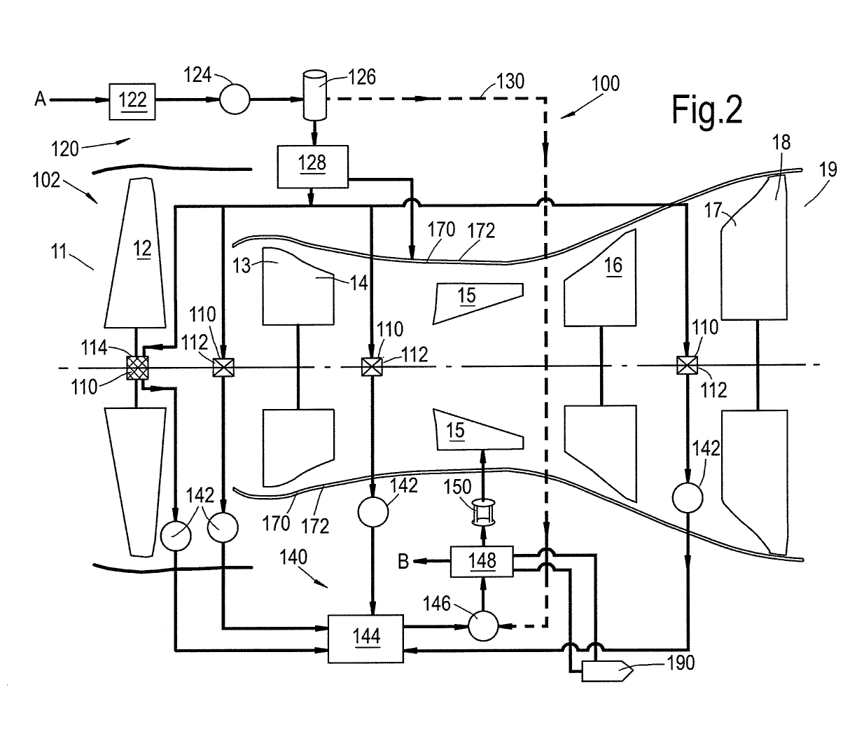

Referring to FIGS. 1 and 2, a thermal management system according to a first embodiment of the disclosure is designated generally by the reference numeral 100.

The thermal management system 100 comprises a plurality of first heat generating sub-systems 110, a fuel supply sub-system 120, and a fuel circulation sub-system 140.

Each of the plurality of first heat generating sub-systems 110 is arranged in operable communication with the engine 102. In the arrangement of the present disclosure, the first heat generating sub-systems 110 include bearing chambers 112 and gearbox 114.

The fuel supply sub-system 120 is adapted to supply a de-oxygenated fuel to the fuel circulation sub-system 140. The fuel circulation sub-system 140 is adapted to circulate the de-oxygenated fuel to lubricate and cool each of the plurality of first heat generating sub-systems 110.

The thermal management system 100 further comprises a plurality of second heat generating sub-systems 170. In the present disclosure the second heat generating sub-systems comprises an engine casing cooler 172, an exhaust nozzle cooler (not shown), and a plurality of turbine air cooling units (also not shown). The fuel circulation sub-system 140 is further adapted to circulate the de-oxygenated fuel to the engine casing cooler 172, the exhaust nozzle cooler, and each of the turbine air cooling units, to cool each of these sub-assemblies.

The fuel supply sub-system 120 comprises a fuel feed line A from a fuel tank (not shown) that provides a supply of fuel to a de-oxygenating unit 122. In other arrangements of the disclosure, the fuel supply sub-system 120 does not include a de-oxygenating unit 122, in which case the fuel tank is filled with a fuel that has previously been de-oxygenated.

From the de-oxygenating unit 122, the de-oxygenated fuel passes to a low pressure pump 124 that delivers the fuel to a filter 126 and then to a metering unit 128. The metering unit 128 then provides separate feeds of pressurised de-oxygenated fuel to each of the first heat generating sub-systems 110 and second heat generating sub-systems 170.

The pressurised de-oxygenated fuel acts to both lubricate and cool each of the bearing chambers 112 and the gearbox 114. A scavenge pump 142 is arranged to collect the de-oxygenated fuel from each of the bearing chambers 112 and the gearbox 114.

The metering unit 128 also provides a feed of pressurised de-oxygenated fuel to each of the engine casing cooler 172, the exhaust nozzle cooler, and each of the turbine air cooling units. The de-oxygenated fuel provides cooling to these sub-assemblies, and a further scavenge pump 142 is arranged to collect the de-oxygenated fuel from each of these suba-assemblies.

The scavenged de-oxygenated fuel then passes through a conditioning unit 144. The conditioning unit 144 acts to filter the fuel after it has passed through each of the bearing chambers 112 and the gearbox 114, and also to de-aerate the fuel.

In the present arrangement, the conditioning unit 144 also performs various monitoring activities on the de-oxygenated fuel. These monitoring activities enable a user to determine the condition of the fuel after it has passed through the first and second heat generating sub-systems 110,170.

From the conditioning unit 144, the de-oxygenated fuel is collected by a high pressure pump 146 that circulates the de-oxygenated fuel to a metering unit 148. From the metering unit 148, the fuel passes through a filter 150 and then to the combustion chamber 15.

The metering unit 148 controls the pressure, delivery rate and timing of the supply of fuel that is delivered to the engine. In the present disclosure, the metering unit 148 is itself controlled by the engine's control unit. Consequently, the quantity of fuel that is supplied to the metering unit by the high pressure pump 146 is likely to be greater than that required to be delivered to the engine's combustion chamber 15. In these circumstances, any excess fuel is returned to the fuel tank via return line B.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person of skill in the art are included within the scope of the disclosure as defined by the accompanying claims.

What is claimed is:

1. A thermal management system for a gas turbine engine, the thermal management system comprising:
a plurality of first heat generating sub-systems arranged in operable communication with the engine;
a fuel supply sub-system;
a fuel circulation sub-system and
one or more combustors,
wherein the fuel supply sub-system is adapted to supply a de-oxygenated fuel to the fuel circulation sub-system, and the fuel circulation sub-system is adapted to circulate the de-oxygenated fuel to lubricate and cool each of the plurality of first heat generating sub-systems, and then to combust the de-oxygenated fuel in the or each combustor.

2. The thermal management system as claimed in claim 1, wherein the fuel circulation sub-system comprises a fuel flow rate modulating sub-system, the fuel flow rate modulating sub-system being adapted to vary a flow rate of the fuel in a pre-determined manner.

3. The thermal management system as claimed in claim 1, wherein the first heat generating sub-systems are selected from the group comprising bearing compartments, gearbox assemblies, and power transmission assemblies.

4. The thermal management system as claimed in claim 1, wherein the thermal management system further comprises a fuel deoxygenating sub-system, the fuel de-oxygenating sub-system being adapted to remove dissolved oxygen from the fuel prior to the de-oxygenated fuel entering the fuel supply sub-system.

5. The thermal management system as claimed in claim 1, the gas turbine engine comprising one or more combustors, the fuel circulation sub-system comprising a bypass fuel feed adapted to supply a fuel feed to the or each combustor, the bypass fuel feed flow rate being independent of the fuel flow rate through each of the plurality of first heat generating sub-systems.

6. The thermal management system as claimed in claim 1, the thermal management system further comprising one or more second heat generating sub-systems,
wherein the second heat generating sub-systems are selected from the group comprising turbine air cooling units, turbine exhaust gas heat recirculators, exhaust nozzle coolers, and engine casing coolers,
wherein the fuel circulation sub-system is further adapted to circulate the de-oxygenated fuel to cool each of the plurality of second heat generating sub-systems.

7. The thermal management system as claimed in claim 1, wherein the fuel is used as a hydraulic medium in one or more hydraulic actuators.

8. The thermal management system as claimed in claim 1, the thermal management system further comprising one or more fuel to air heat exchangers, the or each heat exchanger being configured to transfer heat energy from the fuel to an air flow.

9. An aircraft comprising one or more gas turbine engines, the or each gas turbine engine comprising a thermal management system as claimed in claim 1.

10. A method of managing thermal transfer in a gas turbine engine, the gas turbine engine comprising one or more combustors, the method comprising the steps of:
providing a supply of deoxygenated fuel;
circulating the fuel through a plurality of first heat generating sub-systems arranged in operable communication with the engine to lubricate each of the first heat generating sub-systems;
transferring thermal energy from each of the first heat generating sub-systems to the fuel; and
combusting the fuel in the or each combustor.

11. The method as claimed in claim 10, wherein the first heat generating sub-systems are selected from the group comprising bearing compartments, gearbox assemblies, and power transmission assemblies.

12. The method as claimed in claim 10, wherein the method comprises the additional step of:
circulating the fuel through one or more second heat generating sub-systems arranged in operable communication with the engine to cool each of the second heat generating sub-systems.

13. The method as claimed in claim 12, wherein the second heat generating sub-systems are selected from the group comprising turbine air cooling units, turbine exhaust gas heat recirculators, exhaust nozzle coolers, and engine casing coolers.
